(19) United States
(12) Patent Application Publication
(10) Pub. No.: US 2021/0150514 A1
(43) Pub. Date: May 20, 2021

(54) SYSTEMS AND METHODS FOR AUTHENTICATED TRUST DISTRIBUTION USING BLOCKCHAIN

(71) Applicant: WILLPORTTRUST LLC, San Diego, CA (US)

(72) Inventor: Doris H. SCHWARTZ, San Diego, CA (US)

(73) Assignee: WILLPORTTRUST LLC, San Diego, CA (US)

(21) Appl. No.: 17/097,279

(22) Filed: Nov. 13, 2020

Related U.S. Application Data
(60) Provisional application No. 62/939,189, filed on Nov. 22, 2019.
(60) Provisional application No. 62/937,127, filed on Nov. 18, 2019.

(51) Int. Cl. G06Q 20/38; G06F 16/27; G06F 21/60; G06Q 30/00; G06Q 10/10; G06Q 50/18; G06Q 40/02; G06Q 40/04

(52) U.S. Cl. CPC G06Q 20/389; G06F 16/27; G06F 21/602; G06Q 30/0185; G06Q 40/08; G06Q 50/18; G06Q 40/02; G06Q 40/04; G06Q 10/10

(57) ABSTRACT

Disclosed are systems and methods that includes at least one hardware processor and a memory storing instructions that, when executed by the at least one hardware processor, cause the at least one hardware processor to perform operations including receiving a request for distribution from a first user and a second user, wherein the request initiated by the system upon occurrence of a triggering event.

### CROSS-REFERENCE

This application claims the benefit of U.S. Provisional Application No. 62/937,127, filed Nov. 18, 2019, entitled Authenticated Voucher for Distribution of Funds Upon Occurrence of a Triggering Event Using Blockchain, and U.S. Provisional Application No. 62/939,189, filed Nov. 22, 2019, entitled Authenticated Voucher for Distribution of Funds Upon Occurrence of a Triggering Event Using Blockchain, which applications are incorporated herein in its entirety by reference.

This application is related to U.S. Utility Application 17/097,131 filed concurrently herewith entitled Systems and Methods for Authenticated Voucher Distribution Using Blockchain and U.S. Utility Application ______, filed concurrently herewith entitled Systems and Methods for Authenticated Distribution Upon Occurrence of a Triggering Event Using Blockchain (Attorney Ref. W5370.2131 US [CAO/sf]) both of which claim ultimate priority to U.S. Provisional Application No. 62/937,127, filed Nov. 18, 2019, entitled Authenticated Voucher for Distribution of Funds Upon Occurrence of a Triggering Event Using Blockchain, which applications are incorporated herein in their entirety by reference,

### BACKGROUND

Young people today are facing a savings deficit. In fact, 67% of young millennials (between 18 and 24) and 61% of older millennials (between 25 and 34) have less than $1,000 in savings. Lack of savings and lack of developing good habits related to savings early in life can have a long-term impact on wealth. Those who don't save are unlikely to be wealthy in the future. Young people spend their money on food delivery, travel and their social life. This youth saving trend causes concern for parents, grandparents, aunts and uncles.

Even if some money is directed towards savings, young people often do not have a relationship with an advisor who can guide them in their investing strategy to ensure they are on a path for success later in life.

What is needed is a way to provide funds to a young person via a trust. Further what is needed is a way to provide funds via a trust that establishes an initial relationship with an advisor.

### SUMMARY

Disclosed are systems and methods for administering funds in a trust via a distribution system. The system provides for the electronic transfer at a present or future date using a comprehensive and secure delivery system. The systems and methods are configurable to be integratable into a financial or insurance institution's existing digital delivery framework or configurable to operate as a separate networked platform. Integrity of the distribution system can be provided with the use of, for example, blockchain and/or biometric data. The distribution can be contingent for a period of time.

An aspect of the disclosure is directed to systems comprising: at least one hardware processor; and a memory storing instructions that, when executed by the at least one hardware processor, causes the at least one hardware processor to perform operations in a networked computing environment comprising: receiving a request to create a distribution from a requestor; creating a distribution blockchain; obtaining recipient information from the requestor; appending the recipient information to a distribution blockchain; obtaining one or more distribution source information from the requestor; appending the one or more distribution source information to the voucher blockchain; obtaining a condition for distribution from the requestor; appending the condition for the distribution to the distribution blockchain; obtaining an advisor information from the requestor; appending the advisor information to the distribution blockchain; generating the distribution wherein the distribution comprises a control logic configured to control access to the distribution based on obtaining verification of the condition for distribution and the control logic is executed using the hardware processor configured to receive a first instruction from the recipient to open an account and a second instruction from the advisor to open an account; and appending the distribution to the distribution blockchain. Additionally, the systems can include the instructions further comprising one or more of: obtaining a marital status from the requestor; obtaining spousal information from the requestor; obtaining spousal agreement from a spouse; confirming the marital status; generating a marital status completion block; and appending the marital status completion block to the voucher blockchain. The instructions can further comprise one or more of: obtaining a personalization input from the requestor for the one or more recipients; generating a personalization completion block; and uploading the personalization completion block to the voucher blockchain. In at least some configurations, the instructions further comprise: obtaining a term for the distribution from the requestor; and appending the term of the distribution to the distribution blockchain. Additional instructions can include one or more of: creating a distribution agreement; creating an account set-up form; creating a management agreement; creating an account transfer form; creating a margin agreement; creating an options agreement; creating a money movement agreement; generating a distribution documents completion block containing the one or more created forms and agreements; and appending the distribution documents completion block to the distribution blockchain. Unique hash values can be created for each of the documents reviewed and signed based on a secure hash algorithm in real time and store each unique hash value on the distribution blockchain. Additionally, the system can be configured to further comprise one or more of: notifying the recipient of the distribution; registering the distribution by the recipient; obtaining an approval of redemption documents from the recipient; generating a distribution delivery completion block; and appending the distribution delivery completion block to the distribution blockchain.

Another aspect of the disclosure is directed to computer-implemented methods for account creation in a networked computing environment, the method comprising: receiving a request to create a distribution from a requestor; creating a distribution blockchain; obtaining recipient information from the requestor; appending the recipient information to a distribution blockchain; obtaining one or more distribution source information from the requestor; appending the one or more distribution source information to the voucher blockchain; obtaining a condition for distribution from the requestor; appending the condition for the distribution to the distribution blockchain; obtaining an advisor information from the requestor; appending the advisor information to the distribution blockchain; generating the distribution wherein the distribution comprises a control logic configured to control access to the distribution based on obtaining verification of the condition for distribution and the control logic is executed using the hardware processor configured to receive a first instruction from the recipient to open an account and a second instruction from the advisor to open an account; and appending the distribution to the distribution blockchain. Additionally, the methods can include the instructions further comprising one or more of: obtaining a marital status from the requestor; obtaining spousal information from the requestor; obtaining spousal agreement from a spouse; confirming the marital status; generating a marital status completion block; and appending the marital status completion block to the voucher blockchain. The instructions can further comprise one or more of: obtaining a personalization input from the requestor for the one or more recipients; generating a personalization completion block; and uploading the personalization completion block to the voucher blockchain. In at least some configurations, the instructions further comprise: obtaining a term for the distribution from the requestor; and appending the term of the distribution to the distribution blockchain. Additional instructions can include one or more of: creating a distribution agreement; creating an account set-up form; creating a management agreement; creating an account transfer form; creating a margin agreement; creating an options agreement; creating a money movement agreement; generating a distribution documents completion block containing the one or more created forms and agreements; and appending the distribution documents completion block to the distribution blockchain. Unique hash values can be created for each of the documents reviewed and signed based on a secure hash algorithm in real time and store each unique hash value on the distribution blockchain. Additionally, the method can be configured to further comprise one or more of: notifying the recipient of the distribution; registering the distribution by the recipient; obtaining an approval of redemption documents from the recipient; generating a distribution delivery completion block; and appending the distribution delivery completion block to the distribution blockchain receiving a request to create a distribution from a requestor;

### INCORPORATION BY REFERENCE

All publications, patents, and patent applications mentioned in this specification are herein incorporated by reference to the same extent as if each individual publication, patent, or patent application was specifically and individually indicated to be incorporated by reference.

U.S. Pat. No. 5,878,140 A to Chaum issued Mar. 2, 1999 for Limited-Traceability Systems;

U.S. Pat. No. 9,342,831 B1 to Davis issued May 17, 2016 for Facilitating Same Day Payment Transactions;

U.S. Pat. No. 9,342,741 B2 to Amtrup issued May 17, 2016, for Systems, Methods and Computer Program Products for Determining Document Validity;

U.S. Pat. No. 10,142,347 B2 to Kurian issued Nov. 27, 2018, for System for Centralized Control of Secure Access to Process Data Networks;

U.S. Pat. No. 10,164,779 B2 to Uhr et al., issued Dec. 25, 2018, for System for Issuing Public Certificate on Basis of Block chain, and Method for Issuing Public Certificate on Basis of Block chain by Using Same;

U.S. Pat. No. 10,331,868 B2 to Park issued Jun. 25, 2019, for User Authentication Method and System Using Variable Keypad and Biometric Identification;

U.S. Pat. No. 10,332,115 B2 to Donovan et al., issued Jun. 25, 2019, for Systems and Methods for Processing Metadata Statements in Payment Flows;

U.S. Pat. No. 10,798,094 B2 to Wei issued Oct. 6, 2020, for Blockchain-based account management;

U.S. Pat. No. 10,798, 180 B1 to Gracey et al. issued Oct. 6, 2020 for Systems And Methods For Optimizing Information Collaboration; and

US 2019/0005470 A1 to Uhr, et al., published Jan. 3, 2019, for Accredited Certificate Issuance System Based on Block chain and Accredited Certificate Issuance Method Based on Block chain Using Same, and Accredited Certificate Authentication System Based on Block chain and Accredited Certificate Authentication Method Based on Block chain Using Same.

### BRIEF DESCRIPTION OF THE DRAWINGS

The novel features of the invention are set forth with particularity in the claims. A better understanding of the features and advantages of the present invention will be obtained by reference to the following detailed description that sets forth illustrative embodiments, in which the principles of the invention are utilized, and the accompanying drawings of which:

FIG. 1 is a block diagram illustrating a blockchain system environment suitable for use with the disclosed distribution system;

FIG. 2 is an overview of a trust distribution process;

FIG. 3A is a flow diagram illustrating a portion of the process for creating a user account;

FIG. 3B is a flow diagram illustrating a recipient agreement process;

FIG. 3C is a flow diagram illustrating an advisor process;

FIGS. 4A-B are a flow diagram illustrating a distribution process based on a triggering event; and

FIG. 5 is a flow diagram illustrating a disbursement process.

### DETAILED DESCRIPTION

### I. BLOCKCHAIN PROCESS

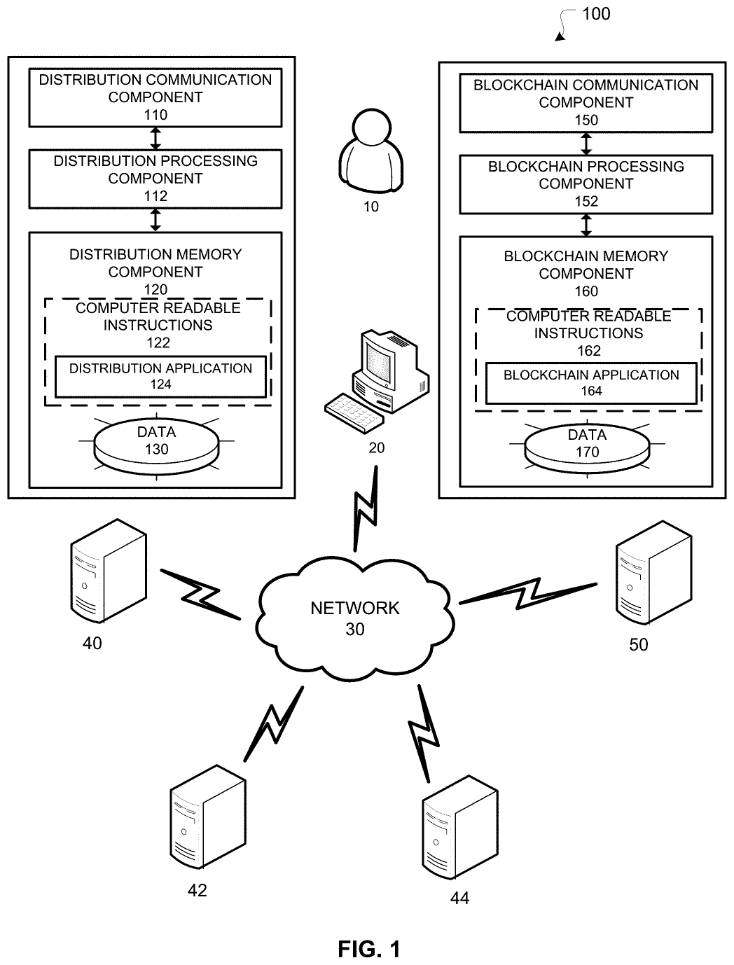

Turning now to FIG. 1, a blockchain and distribution system 100 generally comprises one or more blockchain communication components 150, one or more blockchain processing components 152, and one or more blockchain memory components 160. The one or more blockchain processing components 152 are operatively coupled to the one or more blockchain communication components 150 and the one or more blockchain memory components 160. As will be appreciated by those skilled in the art, processing components and processors generally includes circuitry used for implementing the communication and/or logic functions of a particular system. For example, a blockchain processing component 152 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more blockchain processing components 152 may include functionality to operate one or more software programs based on blockchain computer-readable instructions 162 thereof, which may be stored in the one or more blockchain memory components 160.

The one or more blockchain processing components 152 use the one or more blockchain communication components 150 to communicate with the network 30 and other components on the network 30, such as, but not limited to, the user computer systems 20, first entity systems 40, second entity systems 42, Nth entity systems 44, or other like systems. As such, the one or more blockchain communication components 150 generally comprise a wireless transceiver, modem, server, electrical connection, electrical circuit, or other component for electronically communicating with other components on the network 30. The one or more blockchain communication components 150 may further include an interface that accepts one or more network interface cards, ports for connection of network components, Universal Serial Bus (USB) connectors and the like.

A blockchain can be comprised of one or more blocks (digital information) and/or sub-blockchains which can also be comprised of one or more blocks, in a chain (database). Blocks store information about transactions. A single block on a blockchain can store as much as 1 MB of data (e.g., a few thousand transactions per block). Once a process is completed, the block can be configured so that it cannot be written to following completion. Data, e.g. event records, blocks and/or blockchains (such as sub-blockchains) can be appended to a blockchain. The blockchain distributed ledger provides transparency and immutability. Changes to the blockchain ledger are viewable by all permissioned participants and the corresponding transactions cannot be altered or deleted. Additionally, the system is configurable to generate a unique hash value for each of the block entries, such as documents reviewed and signed, based on a secure hash algorithm in real time and store each unique hash value on the voucher blockchain.

As further illustrated in FIG. 1, the blockchain system 50 comprises blockchain computer-readable instructions 162 stored in the blockchain memory component 160, which in one embodiment includes the blockchain computer-readable instructions 162 of the blockchain application 164. In some embodiments, the one or more blockchain memory components 160 include one or more blockchain data stores 170 for storing data related to the blockchain systems 50, including, but not limited to, data created, accessed, and/or used by the blockchain application 164.

The blockchain systems 50, and the components therein, may be one or more private blockchains, one or more public blockchains, and/or one or more hybrid blockchains. Moreover, the blockchain systems 50 may be located in or associated with the other systems described herein.

Users 10 may access the blockchain application 164 on the one or more blockchain systems 50, or a portion thereof stored on other systems (e.g., a portion of the blockchain application 164 stored on the user computer systems 20 or first entity systems 40, second entity system 42 or nth entity system 44), or through other applications, through a user computer system 20. The user computer system 20 may be a desktop, laptop, tablet, mobile device (e.g., smartphone device, or other mobile device), or any other type of computer that generally comprises one or more voucher communication components 110, one or more distribution processing components 112, and one or more distribution memory components 120.

The one or more distribution processing components 112 are operatively coupled to the one or more distribution communication components 110, and the one or more distribution memory components 120. The one or more distribution processing components 112 use the one or more distribution communication components 110 to communicate with the network 30 and other components on the network 30, such as, but not limited to, the blockchain systems 50, the first entity systems 40, the second entity systems 42, the Nth entity systems 44, or other systems. As such, the one or more distribution communication components 110 generally comprise a wireless transceiver, modem, server, electrical connection, or other component for electronically communicating with other components on the network 30. The one or more blockchain communication components 150 may further include an interface that accepts one or more network interface cards, ports for connection of network components, Universal Serial Bus (USB) connectors and the like. Moreover, the one or more distribution communication components 110 may include a keypad, keyboard, touch-screen, touchpad, microphone, mouse, joystick, other pointer component, button, soft key, and/or other input/output component(s) for communicating with the users 10.

As illustrated in FIG. 1, the user computer systems 20 may have a distribution computer-readable instructions 122 stored in the one or more distribution memory components 120, which in one embodiment includes the distribution computer-readable instructions 122 for distribution applications 124, such as dedicated applications (e.g., apps, applet, or the like), portions of dedicated applications, web browser or other apps that allow access to applications located on other systems, or the like. As previously discussed, the blockchain application 164, or a portion thereof, may be stored on each of the user computer systems 20.

As illustrated in FIG. 1, the first entity systems 40, the second entity systems 42, the Nth entity systems 44, or other systems are operatively coupled to the blockchain systems 50 and/or user computer systems 20, through the network 30. These systems have components that are the same as or similar to the components described with respect to the blockchain systems 50 and/or user computer systems 20 (e.g., one or more communication components, one or more processing components, and one or more memory devices with computer-readable instructions of one or more applications, one or more datastores, or the like). Thus, the first entity systems 40, the second entity systems 42, the Nth entity systems 44, or other systems communicate with the blockchain systems 50, the user computer systems 20, and/or each other in same or similar way as previously described with respect to the blockchain systems 50 and/or the user computer systems 20. The first entity systems 40, second entity systems 42, Nth entity systems 44 may be made up of one or more user computer systems 20, one or more of the blockchain systems 50, or other entity systems that act as nodes which are utilized to store, disseminate, and/or validate event information for events within the blockchain. It should be further understood that the blockchain systems 50 may be separate systems and/or a part of each user computer system 20, and/or first entity systems 40, second entity systems 42, Nth entity systems 44.

Rather than utilizing a centralized database to access, view, store, disseminate, and/or validate information, the present distribution system utilizes a decentralized blockchain configuration or architecture to order to allow users 10 to access, view, store, disseminate, and/or validate information, or take another action related to an event. Such a decentralized blockchain configuration ensures accurate mapping and validation of event information, and provides a secured network over which information may be validated. Accordingly, blockchain configurations may be utilized with respect to any type of information, such as, but not limited to maintaining an accurate ledger of information, such as resource transfer information (e.g., transaction, asset transfer, sale, or other like transfer of value information), personal information, credit history information, or the like, in order to provide validation, such as validation of resource transfers, or access to personal information, or the like.

As will be appreciated by those skilled in the art, a blockchain, or “blockchain,” is a distributed database that maintains a list of data records, the security of which is enhanced by the distributed nature of the blockchain. A blockchain typically includes several nodes, which may be one or more entities, systems within an entity, machines, computers, databases, data stores, or the like operably connected with one another. For example, the various systems described with respect to FIG. 1, or systems within the systems described with respect to FIG. 1 may be nodes. In some aspects of the disclosure, an entity may be a node of a blockchain, and internal users or external users 10 may access the entity systems in order to take actions with respect to an event. In other aspects of the various systems, any nodes may or may not be grouped together and associated with the entity. Each of the nodes or multiple nodes can be maintained by different entities, or components within an entity, and as such different systems within an entity or between entities may act as nodes.

A blockchain typically works without a central repository or single administrator. However, a network of nodes within a single entity or group of entities may together serve as a central repository or single administrator that can control access to the blockchain that is associated with a plurality of different nodes. One application of a blockchain is the public ledger of resource transfers for cryptocurrencies, such as used in bitcoin. In this use of a blockchain, the data records recorded in the blockchain are enforced cryptographically and stored on the nodes of the blockchain within a distribution system. The distributed blockchain network disclosed herein can have at least one private blockchain portion and in some cases a public blockchain portion. The system allows users to take actions (e.g, accessing, viewing, storing, disseminating, validating, or the like) with respect to the distributions. Each block is a time-stamped series of an immutable record of data that is managed by cluster of computers not owned by any single entity. Each of these blocks of data (i.e. block) are secured and bound to each other using cryptographic principles (i.e. chain). Portions of the distributed ledger can form a smart contract which includes an offer, acceptance and consideration.

A blockchain provides numerous advantages over traditional databases. For example, with respect to utilizing a blockchain for resource transfer information, a large number of nodes of a blockchain may reach a consensus regarding the validity of a resource transfer contained on a decentralized resource transfer ledger. Similarly, when multiple versions of a document or resource transfer exits on the ledger, multiple nodes can converge on the most up-to-date version of the resource transfer. For example, in the case of a virtual currency resource transfer, any node within the blockchain that stores or validates the resource transfer, can determine within a level of certainty whether the resource transfer can take place and become final by confirming that no conflicting resource transfers (i.e., the same currency unit has not already been spent) are confirmed by the blockchain elsewhere on other nodes.

The blockchain typically has two primary types of records. The first type is the event type (e.g., resource transfer type, document type, or the like), which consists of the actual data stored in the blockchain. The second type is the block type, which are records that confirm when and in what sequence certain events (e.g., resource transfers, or the like) became recorded as part of the blockchain. Events (e.g., resource transfers, or the like) are created by participants using the blockchain in its normal course of business, (for example, when someone sends cryptocurrency to another person), blocks are created by users known as “miners” who use specialized software/equipment to create the blocks for the event. Users of the blockchain create blocks for the events (e.g., resource transfers, or the like), which are passed around to various nodes of the blockchain. A “valid” resource transfer is one that can be validated based on a set of rules that are defined by the particular system implementing the blockchain.

A distributed ledger (e.g., a decentralized ledger) is maintained on multiple nodes of the blockchain. One node in the blockchain may have a complete or partial copy of the entire ledger or set of events (e.g., resource transfers, or the like) and/or blocks on the blockchain. Events (e.g., resource transfers, or the like) are initiated at a node of a blockchain and communicated to the various other nodes of the blockchain. Any of the nodes, or users of the nodes, which have access to the blockchain to validate an event, add the event to its copy of the blockchain, and/or broadcast the event (e.g., resource transfer or the like) its validation (in the form of a block) and/or other data to other nodes. This other data may include time-stamping.

Various other applications of blockchains may be utilized for the distribution application. These include contract execution, analyst reporting, financial reporting, synchronous/asynchronous communication, controlling access to or dissemination of timeline, personal, and/or financial data and even a general purpose deployment of decentralized applications. As such, blockchains may be utilized to access, view, store, create, disseminate, and/or validate any type of event information, or take any other type of action with respect to event information associated with an event.

In various aspects, the blockchain may be configured with a set of rules (otherwise described herein as “limits”) to dictate what actions may be taken by users and/or nodes for various events, how information may be accessed, created, stored, disseminated, and/or validated, and/or how the network communicates information throughout the one or more blockchains across the nodes of various entities associated with the nodes (e.g., supports the nodes on the entity systems). In some aspects, the rules dictate that an originating node (i.e., a node through which a resource transfer was initiated) must approve all actions for events mapped to that node. In other aspects, the rules dictate that some or all actions for events may be approved by one or more validator nodes without further input from the originating node. In some such cases, the rules dictate that additional information is needed in determining whether an action for an event should be approved. In other aspects, the validating node must reach out to the originating node in certain situations as dictated by the rules. For example, if the action for the event, such as validating a resource transfer, is in any way, indicated to be a faulty or invalid (due to some information present on the blockchain), then the rules may dictate that the validating node communicate with the originating node to confirm or deny validation of the event.

In some aspects, the validator may approve the event (e.g., resource transfer, or the like) without communicating with the originating node. In such a case, the validator (or a group or all of validators if multiple or universal validations, respectively, are required by the rules), can approve the action for the event based solely on the information contained in the blockchain. Thus, if an action for an event is requested and a validator receives the action for the event, it can check the actions for the event against its ledger to determine whether an originating node has validated the event. If so, then the validator may approve the action for the event. In this regard, the action for the event may be approved very quickly, and in some cases, in real-time or near real-time.

In various aspects, any of the blockchain nodes may be a validator or a miner that validates events (e.g., resource transfers, or the like). In some aspects, a number of the nodes must validate an event (e.g., resource transfer, or the like) in order for the event to be approved. For example, in one embodiment, two or three nodes must validate the authenticity of the event, or portions thereof, before the event may be approved. As noted above, in some instances, the rules of the blockchain and/or rules specific to particular originating entities or validators dictate that validators cannot approve events without confirming available information (e.g., funds used in a resource transfer). In some cases, the available information is already associated with an alias on the public blockchain, or associated with a customer within an entity controlling a private blockchain, but in other cases, the validator on the blockchain must communicate with the originating entity in order to request approval of the event (e.g., resource transfer, or the like).

In some aspects, the rules may only be changed by the originating node (maintained by an originating entity or entities that control the blockchain) to ensure the validity of a change to a rule. In some cases, particularly in cases where one or more nodes have raised a concern that an event is not valid, the originating node may be contacted for verification of the event.

In various aspects, the event, or information for the event, is stored and executed from one or more systems and is not placed on the public blockchain itself, and instead is located on a private portion of the blockchain. In some aspects, the event, or information for the event, is only stored and executed from a subset of the nodes of the blockchain, which, in some aspects, are synonymous with validator nodes and in other aspects are not synonymous with the validator nodes. In some aspects, placeholder(s) for the event (e.g., resource transfers, or the like) indicating that the event exists and/or a description of the event, is accessible from private blockchains and may be placed on the public blockchain. The placeholder(s) may be identifiers (e.g., characters, or the like) and/or a description of the event. In some cases, the event may be executed only by the designated one or more systems (e.g., on the private blockchain, or on a private portion of a blockchain). Such systems may utilize a key or other security mechanism(s) in order to ensure only certain nodes are allowed access to the information related to the private blockchain portion. In some cases, this configuration may result in additional security instead of placing the event on the public blockchain for any node to execute.

### II. TRUST OVERVIEW

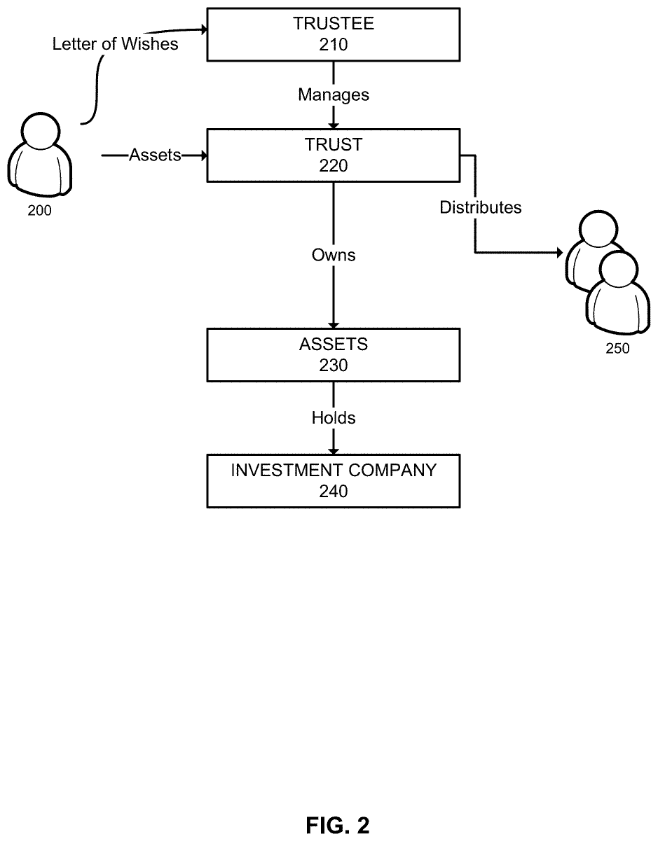

FIG. 2 illustrates an exemplar flow of information from a donor 200 (e.g., the person or user establishing a trust) and a distribution vehicle, such as a trust 220. The donor 200 creates the trust and transfers initial assets 230 (e.g., cash and real property) to the trust. A letter of wishes is provided to the trustee 210. The trust owns the assets 230. Where cash or stocks are involved, an investment company 240 can hold the assets 230 for the trust. Upon occurrence of an event, the trust 220 distributes assets 230 from the trust 220 to the beneficiaries 250 (or recipients) of the trust. An investment company 240 typically has advisors (such as wealth managers) that interface with customers, including donors, users, beneficiaries, recipients, verification contacts, trustees (e.g., trust administrators), and other parties. The occurrence of an event may include a passage of time for the recipient holding an account with an advisor and which point of final transfer is completed. The occurrence of an event can be an actual triggering event or a date certain, as determined by the user.

A variety of trusts are available; trusts typically fall into one of two categories: revocable or irrevocable. A revocable trust is a trust with provisions that can be altered or canceled dependent on the grantor or the originator of the trust (i.e., donor 200). During the life of the revocable trust, income earned can be distributed to the grantor, and only after death does property transfer to the beneficiaries of the trust. In contrast, an irrevocable trust is a trust where its terms cannot be modified, amended or terminated without the permission of the grantor's named beneficiary or beneficiaries.

### III. DISTRIBUTION SYSTEM OVERVIEW

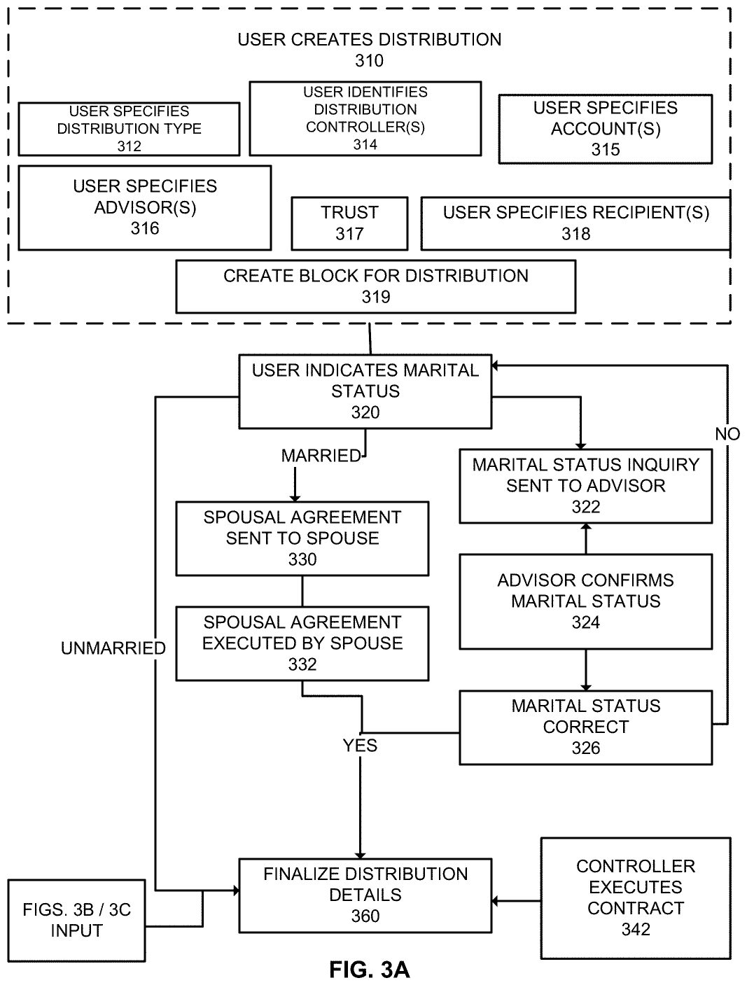

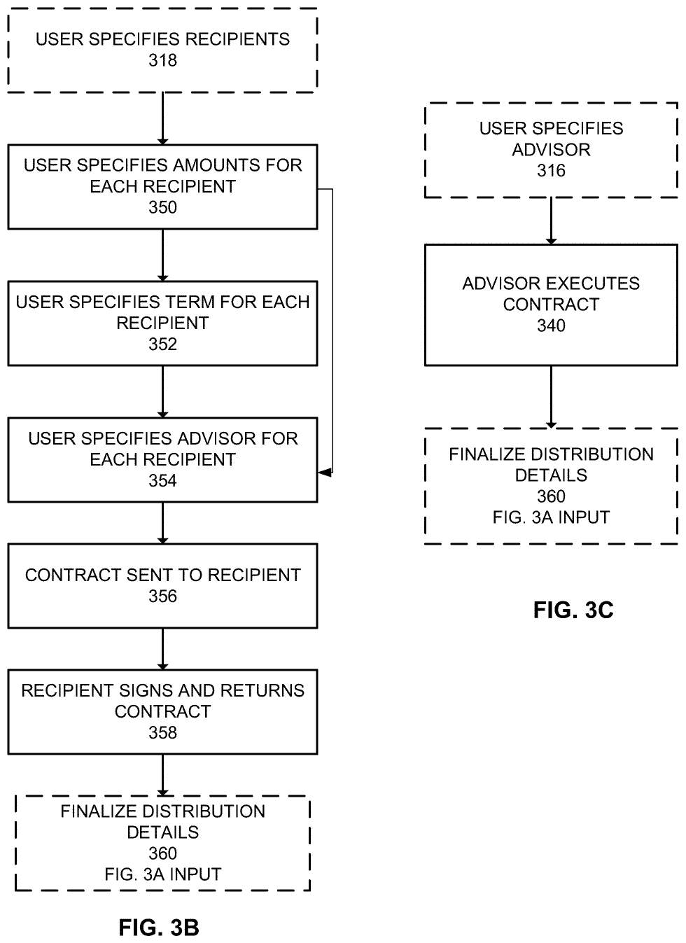

Turning to the disclosed distribution system, in an initial process shown in FIG. 3A, a user creates a distribution 310 for a trust within the system. During the distribution creation process, the user specifies a distribution type 312, identifies one or more controllers 314, specifies one or more accounts 315 to be accessed or associated with a distribution, identifies one or more advisors 316, and identifies one or more recipients 318. During this process, the system creates a block for the blockchain for each distribution 319. The user also identifies the trust 317. The controller 314 is responsible for performing duties associated with managing the distribution via the trust until the final date for distribution occurs.

The distribution system can be a service provider that has a variety of system participants including but not limited to: the account holder (user), the recipient, the beneficiary, the controller, the advisor, the spouse, the verification contact, etc.

During the distribution set-up process, the user can also indicate a marital status 320. If the user is married, then information about the spouse is entered into the distribution system and a spousal consent agreement is sent electronically to the spouse 330. In one configuration, the spouse prints the authorization, signs the authorization 332 in front of a witness or Notary Public, and then returns an electronic copy of the completed document. Return of the electronic copy can occur by any suitable process including, for example, uploading a photo of the signed document via a mobile device. The system can then review the document for legibility to ensure the document appended is the authorization and the information required is present and legible. If the information is not legible, the system can flag the document for human review and/or notify the person uploading the document that the quality of the document is not sufficient. In another configuration, the spouse creates an account with the system and accesses an electronic version of the consent agreement. The spouse is then given the opportunity to accept or reject the agreement. In order to complete the acceptance biometric data, such as a fingerprint, may be required. Thus, for example, in a mobile environment, the spouse would choose, for example, accept and then be required to swipe a known finger across the fingerprint sensor embedded in the phone.

Once the user identifies an advisor and indicates a marital status, a notification is sent to the advisor notifying the advisor that the advisor has been identified as the advisor for the user in the distribution system and requesting the advisor confirm or indicate a marital status 322 for the user. In response to the marital status inquiry 322, the advisor confirms the marital status 324. In one configuration, for example, the advisor can be presented with an option such as “John Smith—married” with a “confirm YES/NO” option. In another configuration, the advisor can be required to independently indicate a marital status for the user. Once the advisor indicates the marital status of the user, the distribution system determines if the marital status is correct 326 by either determining that the advisor has indicated a positive confirmation or has entered the same marital status as the user. If the marital status is correct 326 (YES), then the process proceeds to completion. If the marital status is not correct (NO), then the distribution system notifies the user and requests the information be updated.

If the user is unmarried and the advisor confirms 324 that the user in unmarried, then the distribution details are finalized and the controller executes the contract 342. The controller can have limited or restricted permissions. Permissions for the controller can be set to change upon the occurrence of one or more defined events (e.g., incapacity or death of the user or a date certain or date of any identified triggering event). Once all the components are completed, the distribution is finalized and distribution details are completed 360.

In FIG. 3B, a process of the user identifying recipients 318 is provided in further detail. Once one or more recipients are identified by the user in the distribution system, the user specifies an amount for each distribution recipient 350. The amount becomes associated with a distribution. The user identifies an advisor for each distribution 354. A contract is sent to the distribution recipient 356 identifying the amount and any conditions. The distribution recipient signs and returns the contract 358. Once the distribution recipient signs and returns the contract, the information is provided to the blockchain and the finalized distribution process 360. The process of the user specifying recipients 318 can result in separate blocks of the blockchain for each of the recipients.

The controllers 314 act as administrators and can be set-up as a primary administrator and a back-up administrator. The controllers can be set-up at the account level or the recipient level. In the event the recipient has an action coming due, or a disbursement coming due and the system does not receive confirmation from the recipient, the primary administrator will be advised. Once the primary administrator receives notification of a required action for the administrator, the primary administrator can interact with the recipient to ensure the recipient engages with the system as needed for the event. The administrator may also provide feedback to the system regarding the recipient. In some configurations, the administrator has no control over the funds or their distribution in the system.

In another configuration, the distribution recipient is only notified of the amount and conditions of the intended gift. Notification can occur at the time the user sets-up the account or when an event occurs that results in a distribution. The distribution provides that the specified amount will be placed into an investment account with the advisor for benefit of the user for a period of time after a triggering event, e.g., death of the user. The user can also specifies a term for the distribution 352. For example, the account with the advisor needs to be opened within a period of time from defined event occurrences, and/or held for 12 months, 18 months, etc. The distribution can also be made over a period of time at regular intervals (e.g., monthly or yearly). The process of identifying recipients can be instructed by the user or the controller.

Where the distribution recipient signs and returns the contract 358, return of the electronic copy can occur by any suitable process including, for example, uploading a photo of the signed document via a mobile device.

The system can then review the document for legibility to ensure the document appended is the authorization and the information required is present and legible. If the information is not legible, the system can flag the document for human review and/or notify the person uploading the document that the quality of the document is not sufficient. In another configuration, the distribution recipient creates an account with the system and accesses an electronic version of the distribution agreement. The distribution recipient is then given the opportunity to accept or reject the distribution recipient agreement. In order to complete the acceptance biometric data, such as a fingerprint, may be required. Thus, for example, in a mobile environment, the distribution recipient would choose accept and then be required to swipe a known finger across the fingerprint sensor embedded in the phone. In another configuration, the distribution recipient can print the distribution recipient agreement, sign the agreement in the presence of a Notary Public and then upload a copy of the signed distribution agreement into the system.

Turning now to FIG. 3C, the advisor executes a contract 340 agreeing to manage the investment for the distribution recipient. Once the advisor executes the contract, the information is provided to the blockchain and the finalized distribution process 360.

The system is also configurable to provide a news feed to each participant. The newsfeed advises of upcoming actions and provides for a regular request for update (e.g., annual update request). Alerts and notifications can be provided via the system newsfeed, via text message, via push notification, via email, or any other suitable available mechanism.

Once the one or more defined events occur, specified accounts associated with the system receive a notice. The distribution can be funded from any or all of: the user's estate, the user's administrative trust (former revocable trust), any user's pay on death account, or as a distribution recipient of any of the user's life insurance policies. A similar process could occur in the event of incapacity, as will be appreciated by those skilled in the art. In other implementations, the planned event can be an event such as a college graduation, a 21^{st} birthday, or other date certain or verifiable event.

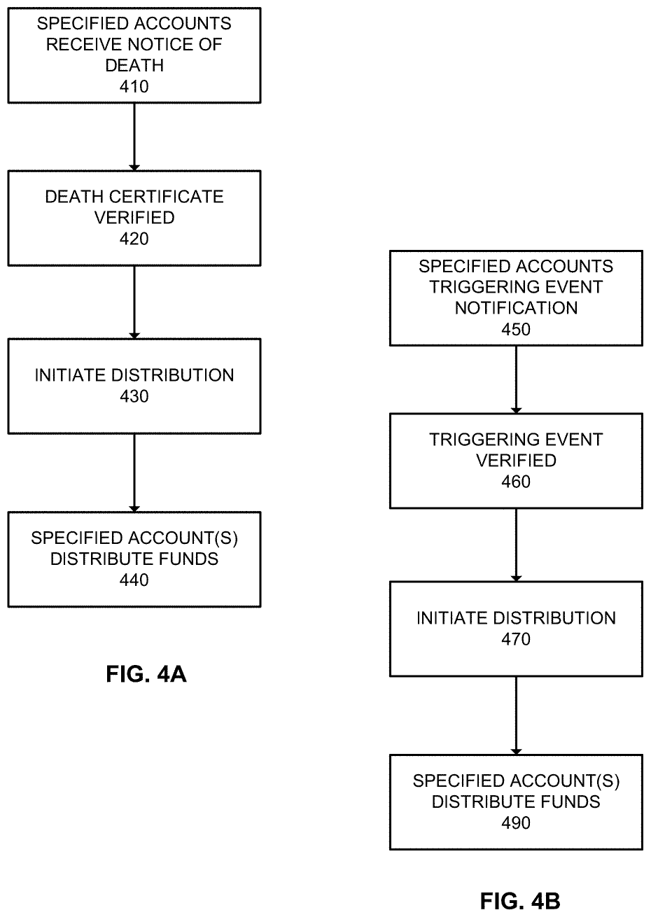

Turning to FIGS. 4A-B, the specified account receives a notice of death 410, for example, or a notice of a triggering event 450. Next, the death certificate is verified 420 or the occurrence of the triggering event is verified 460. Once verification occurs, distribution is initiated 430, 470, and then the funds are distributed 440, 490.

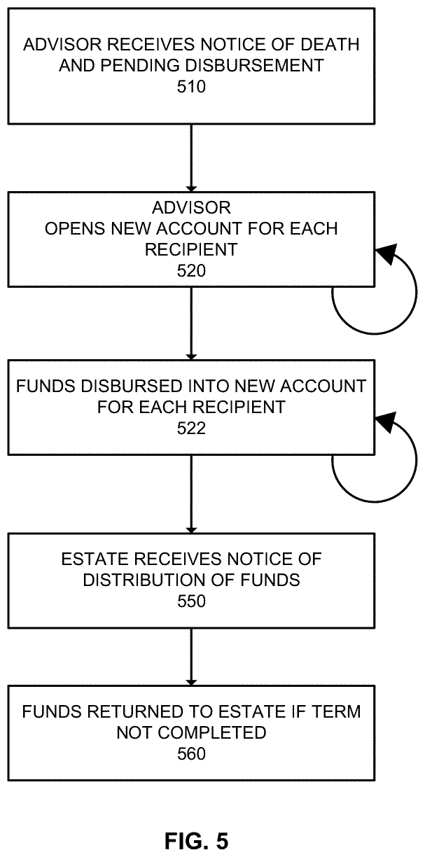

As shown in FIG. 5, once the distributions are initiated, the advisor receives, for example, a notice of death and pending disbursement 510 via the distribution system. As will be appreciated from the disclosure above, the notice can also be a notice of the occurrence of a triggering event identified as part of the distribution (e.g., date certain, completion of a triggering or qualifying event). The notice received or generated (in the case of a date certain) via the distribution system may be in addition to any notice that the advisor receives outside of the distribution system. Once the notice is received, the advisor opens a new account for each distribution recipient 520 associated with the advisor. Funds are then disbursed into the new accounts 522 for the distribution recipient and the controller (e.g., administrator or trustee) for the estate receives a notification of the distribution of funds 550. The account is subject to forfeiture if the recipient does not maintain the account for the term specified.

### IV. EXAMPLES

### Example 1

In a first example, the distribution system user has set-up a legal trust as shown in FIG. 2. The user then enters into an agreement (i.e. contracts) with the distribution system provider to administer a distribution through the trust. The funds for the distribution are distributed from the trust that the user has set-up to the distribution system upon, for example, death of the user. The distribution is transmitted to the advisor identified by the user for the benefit of the distribution recipient.

The distribution recipient is a third-party beneficiary to the agreement between the user and the distribution system provider. In order to receive the benefit of the agreement between the user and the distribution system provider, the distribution recipient is required to open an investment account for the funds with the advisor identified. In some configurations, the recipient may be required to maintain the account for the period of time specified in the agreement between the user and the distribution system provider. If the recipient violates the terms of the agreement, the funds can, for example, revert back to the trust and/or the estate of the user.

### Example 2

In another example, the distribution system user has set-up a distribution as shown in FIG. 3. The user then enters into an agreement (i.e. contracts) with the distribution system provider to administer a distribution. The funds for the distribution are distributed from a source that the user has set-up to the distribution system upon a date certain, such as the 21^{st} birthday of the recipient. The distribution is transmitted to the advisor identified by the user for the benefit of the distribution recipient upon the occurrence of the event.

The distribution recipient is a third-party beneficiary to the agreement between the user and the distribution system provider. In order to receive the benefit of the agreement between the user and the distribution system provider, the distribution recipient is required to open an investment account for the funds with the advisor identified. In some configurations, the recipient may be required to maintain the account for the period of time specified in the agreement between the user and the distribution system provider. If the recipient violates the terms of the agreement, the funds can, for example, revert back to the estate of the user.

### Example 3

In another example, the distribution system user has set-up a distribution as shown in FIG. 3. The user then enters into an agreement (i.e. contracts) with the distribution system provider to administer a distribution. The funds for the distribution are distributed from a source that the user has set-up to the distribution system upon the occurrence of an event, such as matriculation from an educational program of the recipient. The distribution is transmitted to the advisor identified by the user for the benefit of the distribution recipient upon the evidence of the occurrence of the event.

The distribution recipient is a third-party beneficiary to the agreement between the user and the distribution system provider. In order to receive the benefit of the agreement between the user and the distribution system provider, the distribution recipient is required to open an investment account for the funds with the advisor identified. In some configurations, the recipient may be required to maintain the account for the period of time specified in the agreement between the user and the distribution system provider. If the recipient violates the terms of the agreement, the funds can, for example, revert back to the trust and/or estate of the user.

### Example 4

In another example, the distribution system user has set-up a distribution as shown in FIG. 3. The user then enters into an agreement (i.e. contracts) with the distribution system provider to administer a distribution. The user updates distribution instructions over time at the user's discretion.

### Example 5

In another example, the distribution system user has set-up a distribution as shown in FIG. 3. A distribution is triggered and the recipient and/or one or more controllers (administrators) are notified. In the event the recipient does not respond to the notification, the one or more controllers are requested to facilitate distribution to the recipient or release of recipient funds.

### V. COMPUTING ENVIRONMENT OVERVIEW

The systems and methods according to aspects of the disclosed subject matter may utilize a variety of computer and computing systems, communications devices, networks and/or digital/logic devices for operation. Each may, in turn, be configurable to utilize a suitable computing device that can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as an iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web browser, e.g., to provide access to applications and data and other content located on a website or a webpage of a website.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method that may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at sometimes be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

Additionally, a communication system of the disclosure comprises: a sensor as disclosed; a server computer system; a measurement module on the server computer system for permitting the transmission of a measurement from a detection device over a network; at least one of an API (application program interface) engine connected to at least one of the detection device to create a message about the measurement and transmit the message over an API integrated network to a recipient having a predetermined recipient user name, an SMS (short message service) engine connected to at least one of the system for detecting physiological parameters and the detection device to create an SMS message about the measurement and transmit the SMS message over a network to a recipient device having a predetermined measurement recipient telephone number, and an email engine connected to at least one of the detection device to create an email message about the measurement and transmit the email message over the network to a recipient email having a predetermined recipient email address. Communications capabilities also include the capability to communicate and display relevant performance information to the user, and support both ANT+ and Bluetooth Smart wireless communications. A storing module on the server computer system for storing the measurement in a detection device server database can also be provided. In some system configurations, the detection device is connectable to the server computer system over at least one of a mobile phone network and an Internet network, and a browser on the measurement recipient electronic device is used to retrieve an interface on the server computer system. In still other configurations, the system further comprising: an interface on the server computer system, the interface being retrievable by an application on the mobile device. Additionally, the server computer system can be configured such that it is connectable over a cellular phone network to receive a response from the measurement recipient mobile device. The system can further comprise: a downloadable application residing on the measurement recipient mobile device, the downloadable application transmitting the response and a measurement recipient phone number ID over the cellular phone network to the server computer system, the server computer system utilizing the measurement recipient phone number ID to associate the response with the SMS measurement. Additionally, the system can be configured to comprise: a transmissions module that transmits the measurement over a network other than the cellular phone SMS network to a measurement recipient user computer system, in parallel with the measurement that is sent over the cellular phone SMS network.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed:

1. A system comprising:
at least one hardware processor; and
a memory storing instructions that, when executed by the at least one hardware processor, causes the at least one hardware processor to perform operations in a networked computing environment comprising:
receiving a request to create a distribution from a requestor;
creating a distribution blockchain;
obtaining recipient information from the requestor;
appending the recipient information to a distribution blockchain;
obtaining one or more distribution source information from the requestor;
appending the one or more distribution source information to the voucher blockchain;
obtaining a condition for distribution from the requestor;
appending the condition for the distribution to the distribution blockchain;
obtaining an advisor information from the requestor;
appending the advisor information to the distribution blockchain;
generating the distribution wherein the distribution comprises a control logic configured to control access to the distribution based on obtaining verification of the condition for distribution and the control logic is executed using the hardware processor configured to receive a first instruction from the recipient to open an account and a second instruction from the advisor to open an account; and
appending the distribution to the distribution blockchain.

2. The system of claim 1 wherein the instructions further comprises one or more of:
obtaining a marital status from the requestor;
obtaining spousal information from the requestor;
obtaining spousal agreement from a spouse;
confirming the marital status;
generating a marital status completion block; and
appending the marital status completion block to the voucher blockchain.

3. The system of claim 1 wherein the instructions further comprises one or more of:
obtaining a personalization input from the requestor for the one or more recipients;
generating a personalization completion block; and
uploading the personalization completion block to the voucher blockchain.

4. The system of claim 1 wherein the instructions further comprises:
obtaining a term for the distribution from the requestor; and
appending the term of the distribution to the distribution blockchain.

5. The system of claim 1 wherein the instructions further comprises one or more of:
creating a distribution agreement;
creating an account set-up form;
creating a management agreement;
creating an account transfer form;
creating a margin agreement;
creating an options agreement;
creating a money movement agreement;
generating a distribution documents completion block containing the one or more created forms and agreements; and
appending the distribution documents completion block to the distribution blockchain.

6. The system of claim 5 wherein the system is configured to generate a unique hash value for each of the documents reviewed and signed based on a secure hash algorithm in real time and store each unique hash value on the distribution blockchain.

7. The system of claim 6 wherein the instructions further comprises one or more of:
notifying the recipient of the distribution;
registering the distribution by the recipient;
obtaining an approval of redemption documents from the recipient;
generating a distribution delivery completion block; and
appending the distribution delivery completion block to the distribution blockchain.

8. A computer-implemented method for account creation in a networked computing environment, the method comprising:
receiving a request to create a distribution from a requestor;
creating a distribution blockchain;
obtaining recipient information from the requestor;
appending the recipient information to a distribution blockchain;
obtaining one or more distribution source information from the requestor;
appending the one or more distribution source information to the voucher blockchain;
obtaining a term for the distribution from the requestor;
appending the term of the distribution to the distribution blockchain;
obtaining a condition for distribution from the requestor;
appending the condition for the distribution to the distribution blockchain;
obtaining an advisor information from the requestor;
appending the advisor information to the distribution blockchain;
generating the distribution wherein the distribution comprises a control logic configured to control access to the distribution based on obtaining verification of the condition for distribution and the control logic is executed using the hardware processor configured to receive a first instruction from the recipient to open an account and a second instruction from the advisor to open an account; and
appending the distribution to the distribution blockchain.

9. The computer-implemented method of claim 8 wherein the instructions further comprises one or more of:
obtaining a marital status from the requestor;
obtaining spousal information from the requestor;
obtaining spousal agreement from a spouse;
confirming a marital status; and
uploading a marital status completion block to the distribution blockchain.

10. The computer-implemented method of claim 9 wherein the instructions further comprises one or more of:
obtaining a personalization input from the requestor for the one or more recipients; and
uploading a personalization completion block to the distribution blockchain.

11. The computer-implemented method of claim 9 wherein the instructions further comprises one or more of:
creating a voucher agreement;
creating an account set-up form;
creating a management agreement;
creating an account transfer form;
creating a margin agreement;
creating an options agreement;
creating a money movement agreement; and
uploading a voucher documents completion block to the distribution blockchain.

12. The computer-implemented method of claim 10 wherein the instructions further comprises:
obtaining a term for the distribution from the requestor; and
appending the term of the distribution to the distribution blockchain.

13. The computer-implemented method of claim 12 wherein the instructions further comprises one or more of:
notifying the recipient of the distribution;
registering the distribution by the recipient;
obtaining an approval of redemption documents from the recipient; and
uploading a distribution delivery completion block to the distribution blockchain.
